(19) United States
(12) Patent Application Publication
(10) Pub. No.: US 2026/0119099 A1
(43) Pub. Date: Apr. 30, 2026

(54) PRINTING APPARATUS, CONTROL METHOD OF PRINTING APPARATUS, AND STORAGE MEDIUM

(71) Applicant: CANON KABUSHIKI KAISHA, Tokyo (JP)

(72) Inventor: MITSUAKI SAKAMOTO, Kanagawa (JP)

(21) Appl. No.: 19/008,956

(22) Filed: Jan. 3, 2025

(30) Foreign Application Priority Data
Jan. 10, 2024 (JP) 2024-001856

(51) Int. Cl. G06F 3/12; B41J 2/165; B41J 3/46; B41J 11/00; B41J 29/393; G06K 15/02

(52) U.S. Cl. CPC G06F 3/1263; B41J 2/16517; B41J 3/46; B41J 11/0075; B41J 29/393; G06F 3/1207; G06F 3/1235; G06F 3/1267; G06K 15/022; B41J 2002/16573

(57) ABSTRACT

A printing apparatus is a printing apparatus that performs regular cleaning processing on a print mechanism of a roll paper, and includes a storage unit configured to store an inputted print job and a control unit configured to control execution of the print job stored in the storage unit in a predetermined period. In the case where a plurality of the print jobs are stored in the predetermined period, the control unit determines the print job to be preferentially executed based on a remaining time to start of the regular cleaning processing and a total print time taken to execute one or more of the print jobs in which a type of roll paper set in the print mechanism is designated as a type of roll paper to be used among the plurality of print jobs.

### BACKGROUND

### Field

The present disclosure relates to a technology of performing printing on a roll-shaped printing medium.

### Description of the Related Art

Conventionally, in a printing apparatus that performs printing on a roll paper being a roll-shaped printing medium, cleaning processing has been regularly executed to maintain good print quality. Regarding the cleaning processing, Japanese Patent Laid-Open No. 2023-4093 discloses a method in which the cleaning processing is executed in the case where it is a moment before print start or after print end and an accumulated print time that is a total time taken to perform printing after execution of the previous cleaning processing reaches or exceeds a predetermined time. Moreover, Japanese Patent Laid-Open No. 2021-30595 discloses a method in which printing is temporarily stopped at a moment where a total continuous print time reaches a predetermined time, and the cleaning processing is executed.

### SUMMARY

A printing apparatus according to one aspect of the present disclosure is a printing apparatus that performs regular cleaning processing on a print mechanism of a roll paper, and includes a storage unit configured to store an inputted print job, and a control unit configured to control execution of the print job stored in the storage unit in a predetermined period, and in a case where a plurality of the print jobs are stored in the predetermined period, the control unit determines the print job to be preferentially executed based on a remaining time to start of the regular cleaning processing and a total print time taken to execute one or more of the print jobs in which a type of roll paper set in the print mechanism is designated as a type of roll paper to be used among the plurality of print jobs.

Further features of the present disclosure will become apparent from the following description of exemplary embodiments with reference to the attached drawings.

### BRIEF DESCRIPTION OF THE DRAWINGS

FIG. 1 is a configuration diagram of an entire print system including an image forming apparatus;

FIG. 2 is a block diagram of a controller in the image forming apparatus;

FIG. 3 is a software block diagram illustrating a functional configuration of the image forming apparatus;

FIG. 4 is a diagram illustrating a job list example;

FIGS. 5A and 5B are schematic diagrams of print start control;

FIG. 6 is a flowchart illustrating a flow of print mode setting processing;

FIG. 7 is a flowchart illustrating a detailed flow of processing of determining a print range;

FIGS. 8A and 8B are flowcharts illustrating flows of automatic cleaning processing;

FIGS. 9A and 9B are schematic diagrams of print start control in prior reading resume mode setting;

FIGS. 10A to 10D are diagrams for explaining printing processing and cleaning processing;

FIG. 11 is a flowchart illustrating a flow of the print mode setting processing; and

FIGS. 12A and 12B are diagrams illustrating notification screen examples.

### DESCRIPTION OF THE EMBODIMENTS

In the method of Japanese Patent Laid-Open No. 2023-4093 described above, the execution of cleaning processing is limited to the moments before the print start and after the print end. Accordingly, in the case where the accumulated print time exceeds the above-mentioned predetermined time, the cleaning processing after the print end cannot be appropriately executed, and maintaining of print quality is difficult. Moreover, in the method of Japanese Patent Laid-Open No. 2021-30595, the printing is forcedly stopped to execute the cleaning processing. Accordingly, there is a possibility of a productivity decrease due to occurrence of downtime caused by the execution of cleaning processing.

An object of the present disclosure is to provide a technology that suppresses the decrease in productivity while avoiding a decrease in print quality.

Embodiments of the technology of the present disclosure are explained below with reference to the drawings. Note that the following embodiments do not limit the scope of claims. Not all of combinations of features explained in the embodiments are necessarily essential for the solving means of the technology of the present disclosure, and multiple features may be arbitrarily combined. Each of steps in flowcharts are described while being prepended with “S”.

### Embodiment 1

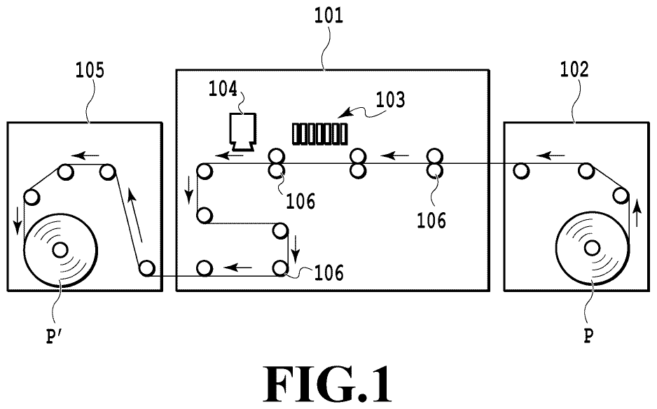

FIG. 1 is a configuration diagram of an entire print system including an image forming apparatus 101 according to the present embodiment. The image forming apparatus 101 is an inkjet printer that forms a print product P′ with a printing unit 103 by ejecting inks to a printing medium P. The printing medium P is fed to the image forming apparatus 101 by a paper feeding unit 102, and the print product P′ is formed in the image forming apparatus 101, and is then collected by a paper discharge unit 105. Rollers 106 causes the printing medium P to pass through a conveyance path. The image forming apparatus 101 inspects an image obtained by a printed image obtaining unit 104 for the print product P′. Note that “printing” not only includes formation of meaningful information such as characters and figures but also widely includes formation of images, designs, patterns, and the like on a printing medium irrespective of whether the formed images, designs, patterns, and the like are meaningful or meaningless. Moreover, the “printing” includes processing of the medium, and whether or not the formed or processed objects are objects made apparent to be visually perceptible to humans does not matter. Furthermore, although the “printing medium” is assumed to be a roll-shaped paper in the present embodiment, the printing medium may be a cloth, a plastic film, or the like. Although components of the inks are not limited to particular components, inks containing water, resins, and pigments that are color materials are assumed to be used in the present embodiment.

### Hardware Configuration of Controller

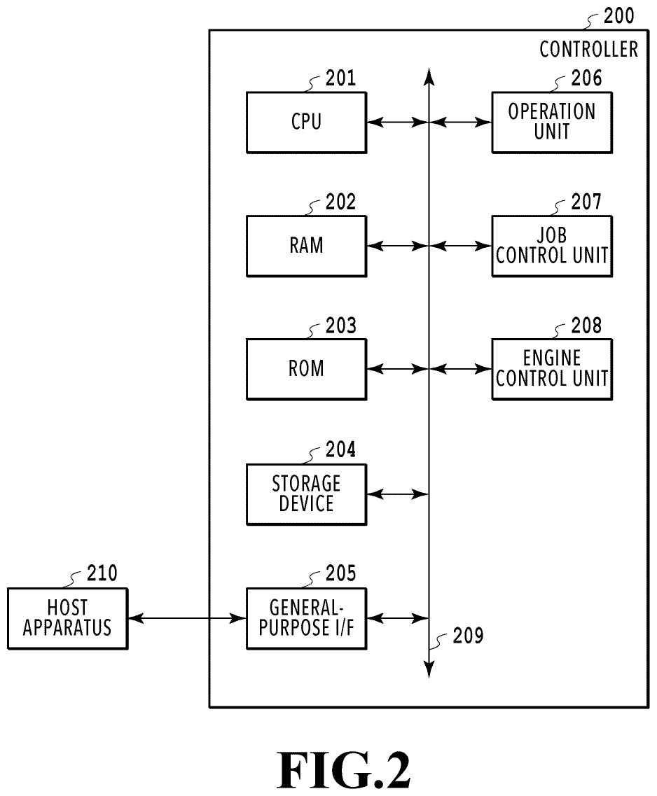

FIG. 2 is a block diagram illustrating a hardware configuration example of a controller 200 in the image forming apparatus 101. The image forming apparatus 101 includes a CPU 201, a RAM 202, a ROM 203, a storage device 204, a general-purpose interface (I/F) 205, an operation unit 206, a job control unit 207, and an engine control unit 208. These devices are connected to one another via a main bus 209 to be capable of exchanging data with one another. A host apparatus 210 is connected to the controller 200 of the image forming apparatus 101 via the general-purpose I/F 205.

The central processing unit (CPU) 201 is a processor that integrally controls the units in the image forming apparatus 101. The random access memory (RAM) 202 functions as a main memory, a work area, and the like of the CPU 201. The read only memory (ROM) 203 stores a program group to be executed by the CPU 201. The storage device 204 stores job information, image data, and the like to be used in printing and an application to be executed by the CPU 201. The general-purpose I/F 205 is Universal Serial Bus (USB), a local area network (LAN), or the like, and receives an input of job data and the like via the host apparatus 210. The operation unit 206 displays a current status and setting on a liquid crystal display capable of handling a touch input or the like to present various pieces of information to a user, and receives a user input such as a print resume instruction or the like. The job control unit 207 performs control relating to printing such as analysis of a print job and determination of print order. The engine control unit 208 performs control on the printing unit 103. The host apparatus 210 prepares the image data and the like necessary for the print job to be processed in the image forming apparatus 101.

### Functional Configuration of Job Control Unit

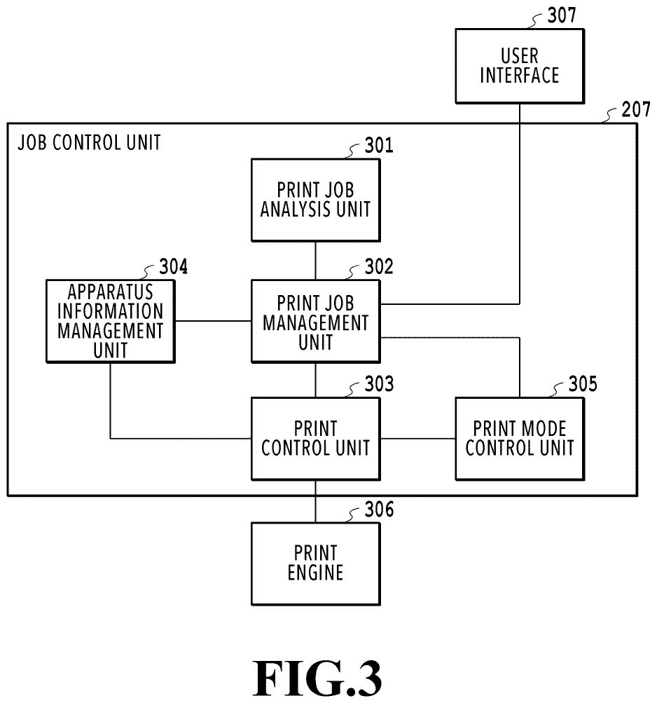

FIG. 3 is a block diagram illustrating a functional configuration example of the job control unit 207 in the image forming apparatus 101. The job control unit 207 includes a print job analysis unit 301, a print job management unit 302, a print control unit 303, an apparatus information management unit 304, and a print mode control unit 305. Moreover, the job control unit 207 communicates with a print engine 306 included in the engine control unit 208 and a user interface 307 on the operation unit 206 via the main bus 209.

The print job analysis unit 301 receives the print job inputted from the host apparatus 210, analyzes the received print job, and obtains the job information such as the number of copies to be printed, print sheet information, and the number of total pages. In the present embodiment, the print job inputted from the host apparatus 210 is formed of a PDF file that is a source of print data and print setting information indicating how an image is to be outputted. A print setting indicates a setting relating to printing such as, for example, one-sided printing or double-sided printing, print quality such as a high-quality mode or a standard mode, and a sheet type such as plain paper or cardboard. Note that the print setting may include setting of parameters corresponding to setting items such as color matching in RIP processing.

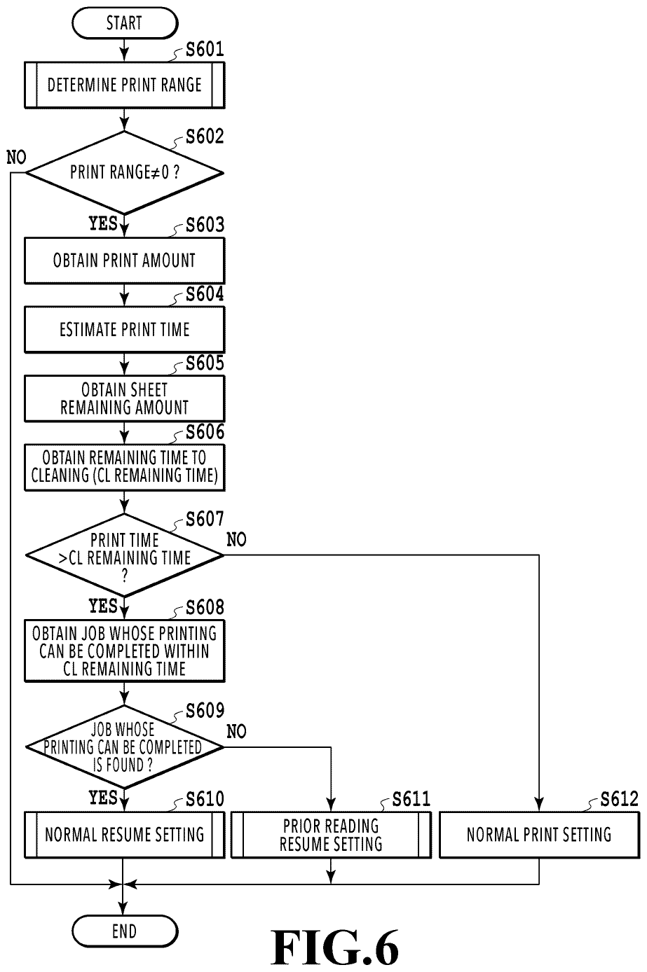

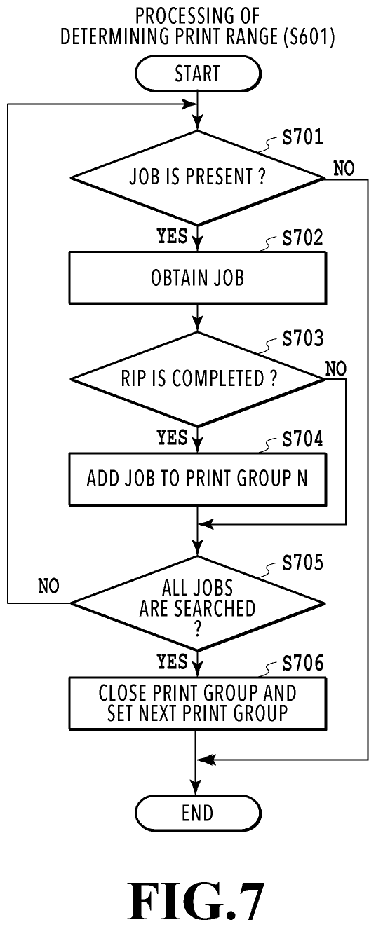

The print job management unit 302 manages the job information obtained by the print job analysis unit 301. Moreover, the print job management unit 302 performs the raster image processor (RIP) processing on the print data included in the received print job, creates bit-map image data, and estimates a print time of the print job based on the created image data. The print time of the print job is a time taken to perform printing based on the print job. Moreover, the print job management unit 302 determines a print range and the print order by using pieces of information held, respectively, by the print control unit 303 and the apparatus information management unit 304 to be described later. Determination of the print range and the print order is explained by using FIG. 7 to be described later. Note that FIG. 7 illustrates a sub-routine of S601 in print mode setting processing illustrated in FIG. 6 to be described later. The print job management unit 302 requests the print control unit 303 to start the printing in the determined print order in the case where the printing is possible.

The print control unit 303 sets a print speed for the print engine 306, and performs a print request according to the print order notified from the print job management unit 302. Moreover, the print control unit 303 controls the print engine 306 in one of a normal mode or a prior reading mode, based on mode information in the print mode control unit 305 to be described later. Furthermore, the print control unit 303 communicates with the print engine 306 to manage an accumulated print time in the print engine 306, and executes automatic cleaning processing in the case where the accumulated print time reaches a specified time. The above-mentioned accumulated print time is a total time taken to perform printing after execution of the previous cleaning processing. The accumulated print time is also referred to as total print time. The above-mentioned specified time may be, for example, a time such as 600 seconds or 3,000 seconds set in advance depending on an apparatus configuration or the like, or a time set as desired. In the execution of cleaning processing, a period of the automatic cleaning processing that is held by the apparatus information management unit 304 to be described later and that is a period in which the cleaning processing is automatically performed is referred to.

The apparatus information management unit 304 manages states of the image forming apparatus 101 such as an already-set sheet, a sheet remaining amount, and an ink remaining amount, and holds apparatus information indicating the states of the image forming apparatus 101 such as the already-set sheet, the sheet remaining amount, and the ink remaining amount. Moreover, the apparatus information management unit 304 holds the period of the automatic cleaning processing. The automatic cleaning processing is processing regularly executed without an input of a job for maintenance. The automatic cleaning processing is also referred to as regular cleaning processing. The automatic cleaning processing is, for example, maintenance processing that needs to be performed on a print mechanism of the roll paper to stabilize print quality such as wiping of a print head (not illustrated) and ink circulation. The print mode control unit 305 manages modes relating to print control such as normal printing and cleaning based on pieces of information on the print job management unit 302 and the print control unit 303, respectively. The print engine 306 executes the printing or the cleaning processing based on an instruction from the print control unit 303.

The user interface 307 displays the job information and the like managed by the print job management unit 302. Moreover, the user interface 307 notifies the print job management unit 302 of user operations such as print start and print stop for the print job. Although the RIP processing is executed in the print job management unit 302 in the present embodiment, a print job including RIP-processing-subjected data obtained by executing the RIP processing in the host apparatus 210 may be received.

### Job Information

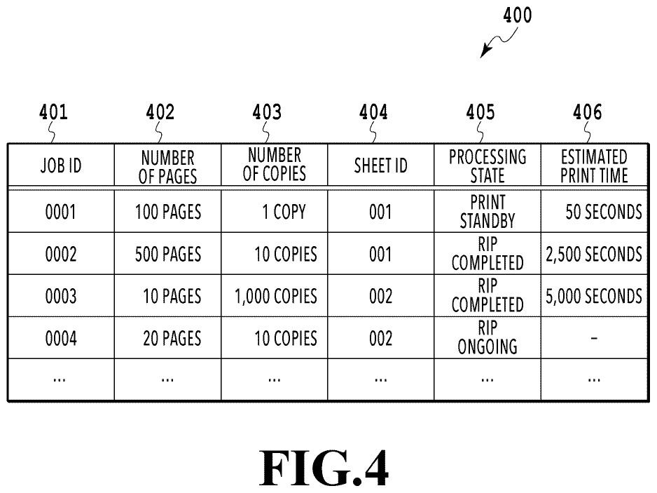

FIG. 4 is a diagram illustrating a job information example. The job information is held in a form of a job list 400 in the print job management unit 302. The job list 400 holds pieces of information relating to the print jobs stored in a predetermined period in the order of input. Note that the print job for which the print request from the user is received after the input from the host apparatus 210 and for which the printing is executed and completed is deleted from the job list. The job list 400 is pieces of information on the respective jobs obtained by analysis by the print job analysis unit 301, and includes information on each of items of a job ID 401, the number of pages 402, the number of copies 403, a sheet ID 404, a processing state 405, and an estimated print time 406. The job list 400 is displayed on the user interface 307.

The job ID 401 is an job identifier issued to each print job by the print job analysis unit 301 every time the print job is inputted into the job control unit 207.

The number of pages 402 is the number of logical pages designating by the print job. The number of copies 403 is information indicating how many times the received print job is repeatedly used, and is information on the number of copies to be printed. The sheet ID 404 is an identifier for identifying a sheet to be used in the printing of the received print job, and is used in the case where information on the sheet such as a sheet width and a sheet type are obtained. The number of pages 402, the number of copies 403, and the sheet ID 404 are each information obtained by analyzing the inputted print job.

The processing state 405 is information indicating a processing state of the received print job, and is set to a state such as “RIP ongoing”, “RIP completed”, “print standby”, “printing”, or the like depending on a processing status of the print job. Note that the “RIP ongoing” indicates a state where the RIP processing is being executed, the “RIP completed” indicates a state where the RIP processing has been already executed, the “print standby” indicates a state where the print job is standing by for the printing processing, and the “printing” indicates a state where the printing processing is being executed.

The estimated print time 406 is an estimated value of the total print time taken to perform the printing in the case where the corresponding print job is executed. The estimated print time 406 is calculated in the print job management unit 302 after the RIP processing for all pages of the corresponding print job, based on a print length of the corresponding print job and a conveyance speed of the printing medium in printing. The print length of the corresponding print job is calculated by a product of a page length per page in a print direction, the number of pages 402, and the number of copies 403. The page length per page in the conveyance direction can be obtained in the RIP processing. The apparatus information management unit 304 obtains the conveyance speed by using information on the sheet ID 404. Note that the print length can be referred to as print amount.

### Print Start Control

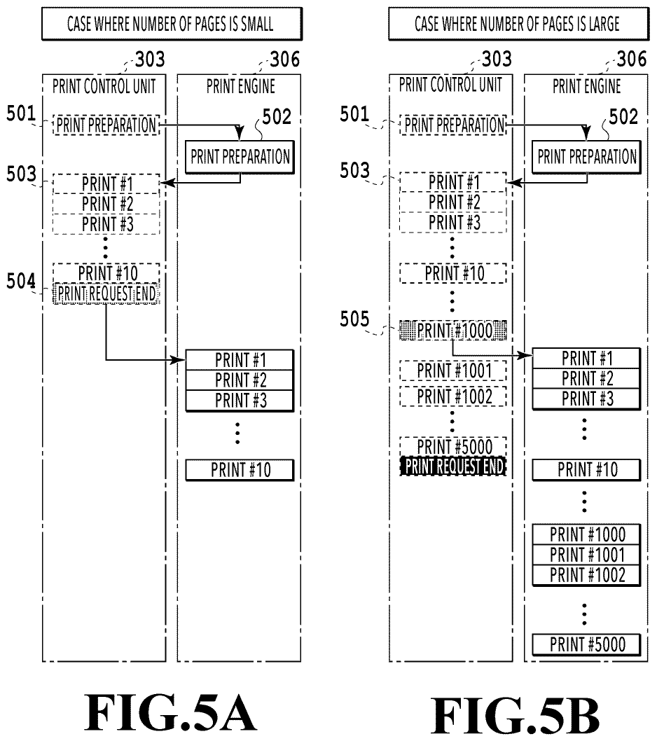

Print start control by the print control unit 303 and the print engine 306 is explained by using FIGS. 5A and 5B. FIGS. 5A and 5B are schematic diagrams of the print start control. FIG. 5A illustrates the case where the number of pages to be continuously printed is small as in the job ID “0001” in the job list 400. FIG. 5B illustrates the case where the number of pages to be continuously printed is large as in the job ID “0002” in the job list 400. Broken lines illustrate control instructions and solid lines illustrate actual control. “Print #1” to “print #5,000” in the print control unit 303 each illustrate a print instruction of a corresponding page, and “print #1” to “print #5,000” in the print engine 306 each illustrate printing of a corresponding page.

Note that the number of pages to be continuously printed being small is the case where the number of pages is smaller than a preset number of pages and where a trigger of print start is a print request end command, the preset number of pages being the number of pieces of data that the print engine 306 can read in advance. The number of pages to be continuously printed being large is the case where the number of pages is larger than the preset number of pages and where the trigger of print start is a print command, the preset number of pages being the number of pieces of data that the print engine 306 can read in advance.

A print start preparation time corresponds to a time from start of print preparation 502 by the print engine 306 to start of printing of a page of “print #1”. Moreover, in FIG. 5A, the print time corresponds to a time from start of printing of the page of “print #1” to end of printing of a page of “print #10” by the print engine 306. In FIG. 5B, the print time corresponds to a time from the start of printing of the page of “print #1” to end of printing of a page of “print #5,000” by the print engine 306.

First, the print control unit 303 issues a print preparation command 501 for causing the print engine 306 to operate, and transmits the issued print preparation command 501 to the print engine 306. The print engine 306 receives the print preparation command 501 issued by the print control unit 303, and performs the print preparation 502 based on the received print preparation command 501. The print preparation 502 is, for example, an operation for apparatus stabilization such as conveyance of roll paper and printing. In the case where the print preparation 502 is completed, the print engine 306 notifies the print control unit 303 of the completion. Next, the print control unit 303 receives the notification of the completion of the print preparation 502 in the print engine 306, and then issues print commands 503 as many as the pages to be printed. Then, the print control unit 303 issues a print request end command 504, and transmits the issued print request end command 504 to the print engine 306. The print engine 306 receives the print request end command 504, sequentially executes printing of the pages for which the printing is requested based on the received print request end command 504, and in the case where the printing of the pages for which the printing is requested is completed, the processing of the print job ends.

A print start timing in the print engine 306 is explained. In order to execute efficient continuous printing, the print engine 306 in the present embodiment starts the printing in a state where the print engine 306 has read a certain number of pieces of the print data in advance to avoid the case where ejection data becomes empty in the middle of printing. In the present embodiment, the number of pieces of data read in advance by the print engine 306 is assumed to be pieces of data for 1,000 pages.

In the case where the number of pages to be printed is small, there is no print requests as many as the certain number of pieces of print data to be read as illustrated in FIG. 5A. Accordingly, the print engine 306 starts the printing upon reception of the print request end command 504. Meanwhile, in the case where the number of pages to be printed is large, the print requests as many as the certain number of pieces of print data to be read can be issued as illustrated in FIG. 5B. In the present embodiment, since the number of pieces of data to be read in advance is pieces of data for 1,000 pages, the print engine 306 determines that a sufficient number of pieces of data read in advance are present in the case where the print engine 306 receives a print command 505 for the 1,000th page, and starts the printing. Note that, in the present embodiment, the print requests for 1001st page and beyond are assumed to be added every time printing of one page is completed. However, the print requests may be made in a unit of 10 pages or the like, at any timing at which the print engine 306 can perform processing.

### Setting Processing of Print Mode

FIG. 6 is a flowchart illustrating a flow of processing in which a print mode is set. Note that the processing illustrated FIG. 6 is executed in the print job management unit 302 in the case where the user makes the print request via the user interface 307.

In S601, the print job management unit 302 obtains the apparatus information indicating the sheet ID of the already-set sheet from the apparatus information management unit 304, searches the job list held by the print job management unit 302 for the corresponding print job by using the obtained apparatus information, and determines the print range. Specifically, the print job management unit 302 temporarily determines the print job to be preferentially executed. Details of the determination processing of the print range are explained by using the drawings.

### Determination Processing of Print Range (S601)

FIG. 7 is a flowchart illustrating a detailed flow of the processing of determining the print range (S601). Note that performing the processing illustrated in FIG. 7 determines the print range and the print order.

In S701, for example, the print job management unit 302 checks whether a print job in which the already-set sheet ID indicated in the apparatus information is designated as the type of roll paper to be used is present in the above-mentioned job list, in the ascending order of numbers. Specifically, the print job management unit 302 checks whether a print job in which the type of roll paper set in the print mechanism is designated as the type of roller paper to be used is present. In the case where the print job management unit 302 obtains a check result indicating that the above-mentioned print job is absent (NO in S701), the flowchart illustrated in FIG. 7 is terminated. In the case where the print job management unit 302 obtains a check result indicating that the above-mentioned print job is present (YES in S701), the processing proceeds to S702.

In S702, the print job management unit 302 obtains the print job in which the sheet ID matching the already-set sheet ID is designated, from the above-mentioned job list. In S703, the print job management unit 302 checks whether the RIP is completed for the print job obtained in S702. In the case where the print job management unit 302 obtains a check result indicating that the RIP is not completed for the print job (NO in S703), the processing proceeds to S705. Meanwhile, in the case where the print job management unit 302 obtains a check result indicating that the RIP is completed for the print job (YES in S703), the processing proceeds to S704. In S704, the print job management unit 302 adds the print job in which the processing state is RIP completed among the print jobs obtained in S702, to a print group N. Specifically, the print job management unit 302 temporarily determines the print group N including multiple print jobs to be preferentially executed.

In S705, the print job management unit 302 checks whether all print jobs in the above-mentioned job list are searched. Specifically, the print job management unit 302 searches all print jobs present in the above-mentioned job list, for the print job for which the check of S701 is not performed. In the case where the print job management unit 302 obtains a check result indicating the search of all print jobs present in the above-mentioned job list is not completed (NO in S705), the processing returns to S701. Meanwhile, in the case where the print job management unit 302 obtains a check result indicating the search of all print jobs present in the above-mentioned job list is completed (YES in S705), the processing proceeds to S706.

In S706, the print job management unit 302 terminates the processing of adding the corresponding print jobs to the print group N being a processing target, and sets a print group (N+1) following the print group N, as the processing target of addition of the print jobs. The print range including the print jobs forming the print group N can be thereby determined. Moreover, in the next execution of the processing of the flowchart illustrated in FIG. 7, the next print range including the print jobs forming the print group (N+1) can be determined. Specifically, the print job management unit 302 can temporarily determine the print group (N+1) including multiple print jobs to be executed preferentially next to the print group N.

Accordingly, in the case where the processing based on the print jobs in which a sheet ID different from the sheet ID of the already-set sheet is designated is to be executed, a plurality of such print jobs can be grouped into one. Note that the print order is determined according to the job information of each print job, in the order of addition to the print group. In the case where the processing of S706 is completed, the flowchart illustrated in FIG. 7 is terminated. Specifically, in the flowchart illustrated in FIG. 7, there is performed grouping in which multiple print jobs in which the sheet ID matching the sheet ID of the already-set sheet is designated and in which the processing state is RIP completed are grouped into one.

Explanation is given by using the case where the sheet ID of the already-set sheet is “001” and the four print jobs illustrated in FIG. 4 are present as an example. In S701, the print job management unit 302 checks whether a job ID in which the sheet ID “001” matching the sheet ID of the already-set sheet is designated is present among the job IDs “0001”, “0002”, “0003”, and “0004”. The print job management unit 302 obtains a check result indicating that the job ID “0001” in which the sheet ID “001” matching the sheet ID of the already-set sheet is designated is present (YES in S701). In S702, the job ID “0001” is obtained. Then, in S703, the print job management unit 302 determines whether the processing state of the job ID “0001” is RIP completed or not. The processing state of the job ID “0001” is RIP completed (YES in S703), and in S704, the job ID “0001” is added to the print group N.

Since not all of the print jobs in the above-mentioned job list are searched (NO in S705), the processing returns to S701. Then, in S701, the print job management unit 302 obtains a check result indicating that the job ID “0002” in which the sheet ID “001” matching the sheet ID of the already-set sheet is designated is present in the above-mentioned job list excluding the job ID “0001” (YES in S701). Then, in S702, the job ID “0002” is obtained. The processing state of the job ID “0002” is RIP completed (YES in S703), and in S704, the job ID “0002” is added to the print group N. Next, in the case where the print job management unit 302 obtains a check result indicating completion of the searching of the above-mentioned job list for all print jobs in which the sheet ID “001” matching the sheet ID of the already-set sheet is designated (YES in S705), the processing proceeds to S706. In S706, the print job management unit 302 closes the print group N to determine the next print range, and the print group (N+1) following the print group N is set.

Moreover, explanation is given by using the case where the sheet ID of the already-set sheet is “002” and the two print jobs with the job IDs “0003” and “0004” illustrated in FIG. 4 are present as an example. In S701, the print job management unit 302 checks whether a job ID in which the sheet ID “002” matching the sheet ID of the already-set sheet is designated is present among the job IDs “0003” and “0004”. The print job management unit 302 obtains a check result indicating that the job ID “0003” in which the sheet ID “002” matching the sheet ID of the already-set sheet is designated is present (YES in S701). In S702, the job ID “0003” is obtained. Then, the print job management unit 302 determines whether the processing state of the job ID “0003” is RIP completed. The processing state of the job ID “0003” is RIP completed (YES in S703), and in S704, the job ID “0003” is added to the print group (N+1).

Since not all of the print jobs in the above-mentioned job list are searched (NO in S705), the processing returns to S701. Then, in S701, the print job management unit 302 obtains a check result indicating that the job ID “0004” in which the sheet ID “002” matching the sheet ID of the already-set sheet is designated is present in the above-mentioned job list excluding the job ID “0003” (YES in S701). Next, in S702, the job ID “0004” is obtained. Since the processing state of the job ID “0004” is RIP ongoing, the processing state is not RIP completed (NO in S703), and the processing proceeds to S705. Then, in the case where the print job management unit 302 obtains a check result indicating completion of the searching of the above-mentioned job list for all print jobs in which the sheet ID “002” matching the sheet ID of the already-set sheet is designated (YES in S705), the processing proceeds to S706. In S706, the print job management unit 302 closes the print group (N+1) to determine the next print range, and a print group (N+2) following the print group (N+1) is set.

Returning to the explanation of the flowchart of FIG. 6, in S602, the print job management unit 302 checks whether the print range is determined according to the flowchart illustrated in FIG. 7. In the case where the print job management unit 302 obtains a check result indicating that the print range cannot be determined (print range=0) such as the case where the print job in which the sheet ID matching the sheet ID of the already-set sheet is designated is absent (NO in S602), the flowchart illustrated in FIG. 6 is terminated. In the case where the print job management unit 302 obtains a check result indicating that the print range is determined (print range≠0) (YES in S602), the processing proceeds to S603.

In S603, the print job management unit 302 obtains the print amount for the print jobs included in the print range. Specifically, the print job management unit 302 obtains the print amount of the print jobs whose print targets are the print range determined in S601. In S604, the print job management unit 302 estimates the print time in the case where printing based on all print jobs included in the print range is performed. Specifically, the print job management unit 302 estimates the print time taken to perform the printing based on all print jobs whose print targets are the print range determined in S601. Information obtained in calculation of the print time of each job is used for the print amount. The estimated print time 406 managed in the job list 400 is used for the print time.

In S605, the print job management unit 302 obtains the sheet remaining amount from the apparatus information held in the apparatus information management unit 304. In S606, the print job management unit 302 obtains a remaining time to the start of cleaning. The remaining time to the start of cleaning (hereinafter, referred to as CL remaining time) is calculated based on a difference between the period of the automatic cleaning processing held in the apparatus information management unit 304 and the accumulated print time managed in the print control unit 303.

In S607, the print job management unit 302 compares the print time obtained in S604 with the CL remaining time obtained in S606, and determines whether the printing is completed within the CL remaining time based on a comparison result. In the case where the print job management unit 302 obtains a determination result indicating that the entire printing is completed within the CL remaining time (NO in S607), the processing proceeds to S612. Specifically, in the case where the total print time taken to execute the print jobs in which the type of roll paper set in the print mechanism is designated as the type of roll paper to be used among the multiple print job stored in the predetermined period is not longer than the CL remaining time, the processing proceeds to S612. Meanwhile, in the case where the print job management unit 302 obtains a determination result indicating that the printing is not completed within the CL remaining time (YES in S607), the processing proceeds to S608. Specifically, in the case where the total print time taken to execute the print jobs in which the type of roll paper set in the print mechanism is designated as the type of roll paper to be used among the multiple print jobs stored in the predetermined period is longer than the CL remaining time, the processing proceeds to S608.

In S608, the print job management unit 302 obtains the print job whose printing can be completed within the CL remaining time from among all print jobs included in the print range. Specifically, the print job management unit 302 obtains the print job whose printing can be completed within the CL remaining time from among all print jobs whose print targets are the print range determined in S601.

In S609, the print job management unit 302 checks whether the job whose printing can be completed within the CL remaining time is found. In the case where the print job management unit 302 obtains a check result indicating that the job whose printing can be completed within the CL remaining time is found (YES in S609), the processing proceeds to S610. In the case where the print job management unit 302 obtains a check result indicating that the printable job is not found (NO in S609), the processing proceeds to S611.

In S610, the print job management unit 302 sets a normal resume mode for the print mode control unit 305. Specifically, the print job management unit 302 sets the normal resume mode in which the print job that is obtained in S608 and whose printing can be completed within the CL remaining time is executed. The normal resume mode is set because the print job management unit 302 determines that the execution of the cleaning processing is possible between print jobs after resetting. Details of setting processing of the normal resume mode are described later by using the drawings.

In S611, the print job management unit 302 sets a prior reading resume mode for the print mode control unit 305. Specifically, the print job management unit 302 sets the prior reading resume mode in which printing up to a page whose printing can be completed within the CL remaining time is performed and the print job to be executed after the regular cleaning processing is read during the regular cleaning processing. The prior reading resume mode is set because the print job management unit 302 determines that the regular cleaning processing needs to be executed in the middle of printing based on the print job being processed, and setting the prior reading resume mode can minimize the downtime caused by execution of the regular cleaning processing. Details of the setting processing of the prior reading resume mode are described later by using the drawings.

In S612, the print job management unit 302 sets a normal print mode for the print mode control unit 305. Specifically, the print job management unit 302 sets the normal print mode in which the print job corresponding to the print range temporarily determined in S601 is executed. The normal print mode is set because the print job management unit 302 determines that the automatic cleaning processing can be executed between print jobs without re-determination of the print range. Note that the setting processing of the normal print mode is processing of executing the print job corresponding to the print range determined in S601 without executing the regular cleaning processing in the state where the printing is suspended. The setting processing of the normal print mode is, for example, processing in which the printing processing based on the print job is executed between operations of the regular cleaning processing as illustrated in FIGS. 5A and 5B.

Note that the flowchart illustrated in FIG. 6 is terminated in the case where one of the processes of S610, S611, and S612 is completed.

### Automatic Cleaning Processing

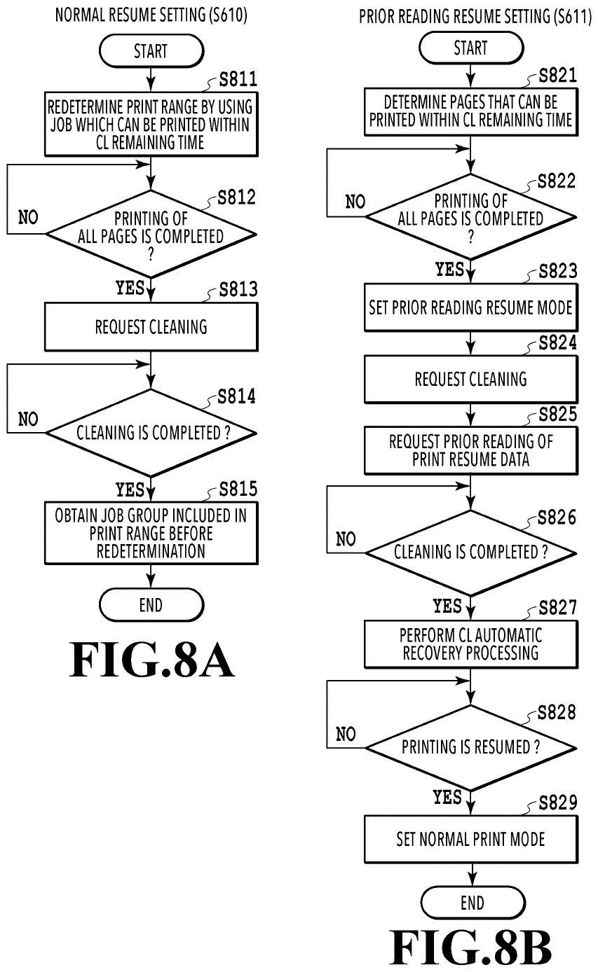

FIGS. 8A and 8B are each a flowchart explaining the automatic cleaning processing in one of the corresponding print modes set in the flowchart illustrated in FIG. 6.

### Normal Resume Setting Processing (S610)

FIG. 8A is a flowchart illustrating a detailed flow of normal resume setting processing (S610).

In S811, the print job management unit 302 redetermines the print range determined in S601 to be a print range based on an analysis result obtained by analyzing the print job that is found in S609 and whose printing can be completed within the CL remaining time. Specifically, the print job management unit 302 determines the print job that is obtained in S608 and whose printing can be completed within the CL remaining time, as the print job to be preferentially executed. In S812, the print job management unit 302 performs a print request for the print job included in the print range redetermined in S811, and waits until printing of all pages is completed. Specifically, the print job management unit 302 performs a print request for the print job whose print target is the print range determined in S811, and waits until printing of all pages is completed. In the case where the print job management unit 302 obtains a determination result indicating that the printing of all pages is not completed (NO in S812), the process of S812 is executed again. Meanwhile, in the case where the print job management unit 302 obtains a determination result indicating that the printing of all pages is completed (YES in S812), the processing proceeds to S813.

In S813, the print job management unit 302 executes processing of requesting the print engine 306 to perform the cleaning processing. Note that the print engine 306 executes the cleaning processing upon receiving the above-mentioned request. In S814, the print job management unit 302 waits until the cleaning processing executed in the print engine 306 in response to the request of S813 is completed. In the case where the print job management unit 302 obtains a determination result indicating that the cleaning processing is not completed (NO in S814), the process of S814 is executed again. Meanwhile, in the case where the print job management unit 302 obtains a determination result indicating that the cleaning processing is completed (YES in S814), the processing proceeds to S815.

In S815, the print job management unit 302 obtains a print job group included in the print range before the redetermination. In the normal resume mode, since operations such as sheet replacement, sheet replenishment, and changing of print order may be performed, the print job management unit 302 waits for an instruction of print resume from the user. The print job management unit 302 performs setting such that the print jobs originally expected to be printed can be preferentially printed by using the print jobs obtained in S815 and included in the print range before the redetermination in the case where the print job management unit 302 receives the instruction of print resume from the user. Specifically, the print job management unit 302 determines the print jobs whose printing cannot be completed within the CL remaining time among the print jobs in which the type of roll paper set in the print mechanism is designated, as the print jobs to be preferentially executed. In the case where the process of S815 is completed, the flowchart illustrated in FIG. 8A is terminated.

### Prior Reading Resume Setting Processing (S611)

FIG. 8B is a flowchart illustrating a detailed flow of prior reading resume setting processing (S611).

In S821, the print job management unit 302 determines pages that can be printed within the CL remaining time. The pages are determined because printing based on a print job group whose print target is the print range determined in S601 does not complete within the CL remaining time, and determining the pages allows the print job group to be divided into print jobs whose printing is completed within the CL remaining time.

In S822, the print job management unit 302 waits until printing of all pages up to the pages determined in S821 is completed. In the case where the print job management unit 302 obtains a determination result indicating that the printing of all pages up to the pages determined in S821 is not completed (NO in S822), the process of S822 is executed again. Meanwhile, in the case where the print job management unit 302 obtains a determination result indicating that the printing of all pages up to the pages determined in S821 is completed (YES in S822), the processing proceeds to S823.

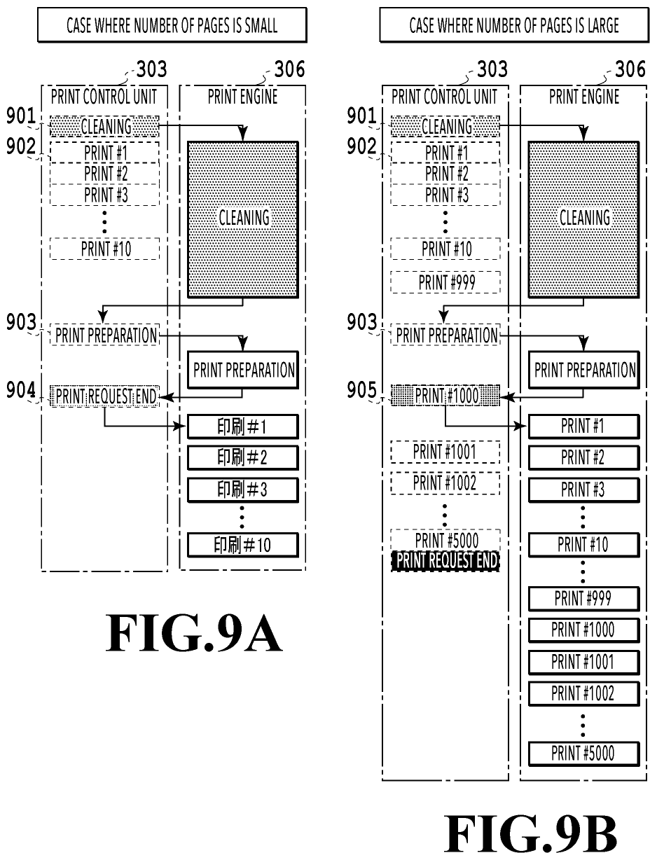

In S823, the print job management unit 302 sets the prior reading resume mode before the execution of cleaning processing. The prior reading resume mode is a mode in which the print commands 503 excluding the print request end command 504 and the print command 505 that are the triggers of print start in FIGS. 5A and 5B are issued, and the print engine 306 is made to execute prior reading of the print data. Processes after S823 are explained specifically in FIGS. 9A and 9B to be described later.

In S824, the print job management unit 302 executes processing of requesting the print engine 306 to perform the cleaning processing. Note that the print engine 306 executes the cleaning processing upon receiving the above-mentioned request.

In S825, the print job management unit 302 executes a prior reading request for data whose printing is to be resumed after the cleaning processing. Specifically, the print job management unit 302 reads pages that cannot be printed within the CL remaining time.

In S826, the print job management unit 302 waits until the cleaning processing executed in the print engine 306 in response to the request of S824 is completed. In the case where the print job management unit 302 obtains a determination result indicating that the cleaning processing is not completed (NO in S826), the process of S826 is executed again. Meanwhile, in the case where the print job management unit 302 obtains a determination result indicating that the cleaning processing is completed (YES in S826), the processing proceeds to S827.

In S827, the print job management unit 302 performs automatic recovery processing after the cleaning processing. More specifically, the print job management unit 302 receives notification of cleaning completion, issues the print preparation command 501 for start of the printing explained in FIGS. 5A and 5B, and issues a command to be a trigger of print start after completion of the print preparation 502.

In S828, the print job management unit 302 checks whether the printing is resumed. Note that, in the present embodiment, the printing is determined to be resumed in the case where print completion notification of the first page is received after the automatic recovery processing (S827). In the case where the print job management unit 302 obtains a determination result indicating that the printing is not resumed (NO in S828), the process of S828 is executed again. In the case where the determination result indicating that the printing is resumed is obtained (YES in S828), the processing proceeds to S829.

In S829, the print job management unit 302 sets the normal print mode. Specifically, the print job management unit 302 changes the print mode from the prior reading resume mode to the normal print mode. In the case where the process of S829 is completed, the flowchart illustrated in FIG. 8B is terminated.

### Print Start Control in Prior Reading Resume Mode Setting

The processes after the process of setting the prior reading resume mode (S823) are explained by using FIGS. 9A and 9B. FIGS. 9A and 9B are schematic diagrams of print start control in the prior reading resume mode setting. FIG. 9A illustrates the case where the number of pages to be printed after completion of the cleaning is small, and is 10 pages. FIG. 9B illustrates the case where the number of pages to be printed after completion of the cleaning is large, and is 5,000 pages. Broken lines illustrate control instructions, and solid lines illustrate actual control. “Print #1” to “print #5,000” in the print control unit 303 each illustrate a print instruction of a corresponding page, and “print #1” to “print #5,000” in the print engine 306 each illustrate printing of a corresponding page. In the present embodiment, the number of pieces of data read in advance by the print engine 306 is assumed to be pieces of data corresponding to 1,000 pages as in FIGS. 5A and 5B.

In the case where the number of pages to be printed is small, in S824, as illustrated in FIG. 9A, the print job management unit 302 issues a cleaning command 901 after the prior reading resume mode setting. Then, the print control unit 303 transmits the cleaning command 901 issued in the print job management unit 302 to the print engine 306. Specifically, the print job management unit 302 requests the print engine 306 to execute the cleaning processing. Since the print requests as many as the certain number of pieces of print data to be read cannot be issued in the present case, a print request end command 904 is necessary to start the printing. Specifically, the print engine 306 does not perform printing unless the print engine 306 receives the print request end command 904 issued in the print control unit 303. Accordingly, in S825, the print job management unit 302 issues print commands 902 for all pages as the print requests, and causes the print engine 306 to execute the prior reading of the print data. After completion of the cleaning, in S827, the print job management unit 302 performs the automatic recovery processing after the cleaning processing that is processing for resuming printing. Specifically, in S827, first, the print job management unit 302 issues a print preparation command 903 to request print preparation. Then, the print control unit 303 transmits the print preparation command 903 issued in the print job management unit 302 to the print engine 306, and causes the print engine 306 to execute the print preparation. The print preparation in the print engine 306 is an operation for apparatus stabilization such as, for example, conveyance of roll paper and printing. Normally, the print requests for the print target pages are performed after the print preparation. However, in the prior reading resume mode, the print requests are already issued due to the prior reading. Accordingly, after the completion of print preparation, the print job management unit 302 causes the print engine 306 to start printing by issuing the print request end command 904 that is the trigger of print start.

Meanwhile, in the case where the number of pages to be printed is large, as illustrated in FIG. 9B, the cleaning command 901 is issued, and then the control of issuing the print commands 902 as the print requests is performed as in the case of FIG. 9A. In the present case, since the number of pages to be printed after completion of the cleaning is sufficient, the print commands for requesting printing are issued up to a limit value of the number of pieces of print data readable by the print engine 306 in advance. Since the number of pieces of data read by the print engine 306 in advance is pieces of data for 1,000 pages in the present embodiment, the print commands for requesting printing to a 999th page are issued. After completion of cleaning, the print preparation is performed. Specifically, the print job management unit 302 issues the print preparation command 903 to request the print preparation. Then, the print control unit 303 transmits the print preparation command 903 issued in the print job management unit 302 to the print engine 306, and causes the print engine 306 to perform the print preparation. Next, the print job management unit 302 issues the print command “print #1000” 905 for requesting printing of a 1000th page that is the trigger of print start. Thereafter, the print control unit 303 sequentially issues the print commands as in the normal state, and issues the print commands for all pages in the print range.

### Each Pring Mode

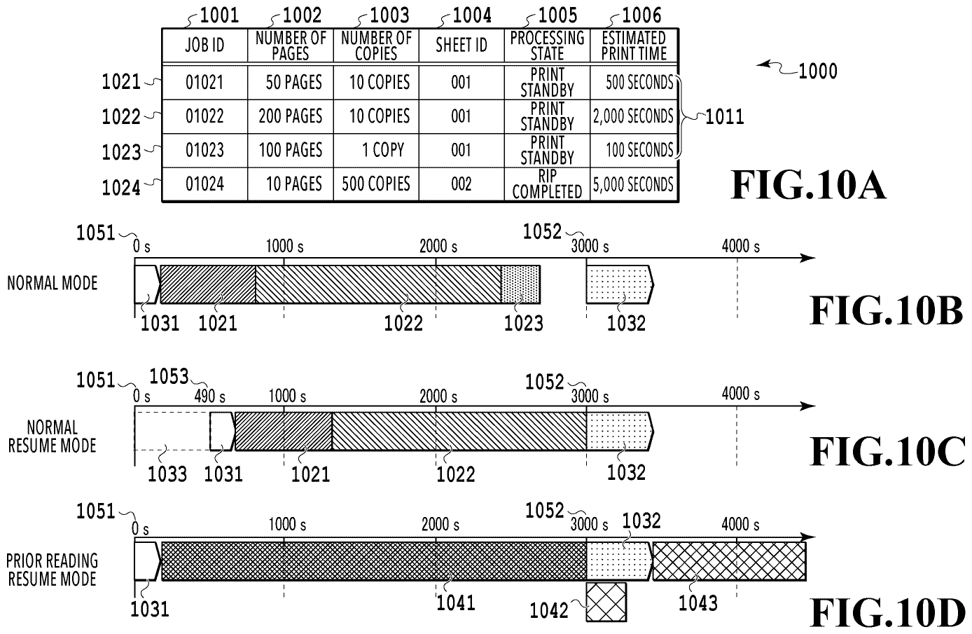

Details of each print mode are explained by using FIGS. 10A to 10D. FIGS. 10A to 10D are diagrams for explaining the printing processing and the cleaning processing in each print mode. FIG. 10A illustrates a job information example in a list form. Information on each of four print jobs to be processing targets are registered in a job list 1000. The estimated print time of each print job is assumed to be already calculated. Information on a job ID 1001, the number of pages 1002, the number of copies 1003, a processing state 1005, and an estimated print time 1006 of each print job is assumed to be registered in the job list 1000 for each print job.

Moreover, a print range 1011 is also assumed to be already determined as a range of targets for which continuous printing is to be performed. The print range 1011 includes three print jobs of a print job 1021, a print job 1022, and a print job 1023. Since a sheet ID 1004 “002” of the print target in a print job 1024 is different from the sheet ID 1004 “001” of the print target in the print jobs 1021 to 1023, the print job 1024 is not included in the print range 1011, and is determined as a print range different from the print range 1011. Moreover, the following explanation is given assuming that a period of regular cleaning processing (automatic cleaning processing) 1032 is 3,000 seconds, and print preparation time 1031 is 10 seconds. Note that, since the regular cleaning processing 1032 is automatically executed, the regular cleaning processing 1032 can be also referred to as automatic cleaning processing.

### In Normal Print Mode Setting

FIG. 10B is a diagram for explaining the printing processing and the cleaning processing in the normal print mode setting (in the normal mode setting) set in S612. An accumulated print time 1051 is 0 seconds, and indicates a state just after activation or just after completion of cleaning. In the present case, three print jobs of the print jobs 1021, 1022, and 1023 whose print targets are the print range 1011 are expected to be continuously printed. The print time for the print range 1011 including the print preparation time 1031 is 10+500+2,000+100=2,610 seconds. Since the accumulated print time 1051 is 0 seconds, the CL remaining time 1052 is 3,000 seconds. The total print time of the print jobs whose print targets are the print range 1011 is 2,600 seconds, and entire printing can be completed within the CL remaining time of 3,000 seconds. Accordingly, the printing is directly executed. The regular cleaning processing 1032 is executed at a moment where a fixed time comes.

### In Normal Resume Mode Setting

FIG. 10C is a diagram for explaining the printing processing and the cleaning processing in the normal resume mode setting (in the normal resume setting) set in S610. Also in the present case, the three print jobs of the print jobs 1021, 1022, and 1023 whose print targets are the print range 1011 are expected to be continuously printed as in FIG. 10B. Moreover, an accumulated print time 1053 is in a state where prior processing 1033 such as maintenance is executed after completion of previous cleaning processing and 490 seconds has elapsed from the completion of previous cleaning processing. Accordingly, the CL remaining time is 3,000−490=2,510 seconds. The total print time for the print range 1011 including the print preparation time 1031 is 2,610 seconds, and exceeds the CL remaining time of 2,510 seconds. Accordingly, the print range is redetermined to include print jobs whose printing can be completed within the CL remaining time of 2,510 seconds. In the present case, the print job 1023 is excluded from the print range 1011, and only the print jobs 1021 and 1022 are printed. Redetermination of the print range causes the total print time to be 2,510 seconds, and the printing of the print jobs 1021 and 1022 can be completed within the CL remaining time. Then, after completion of printing of the print job 1022, the regular cleaning processing 1032 is executed. Note that printing of the print job 1023 excluded from the print range after the redetermination by the redetermination of the print range is not resumed until the print resume instruction from the user is received. In the case where the print resume instruction from the user is received, a new print range including the print job 1023 is determined, and the processing is performed.

### In Prior Reading Resume Mode Setting

FIG. 10D is a diagram for explaining the printing processing and the cleaning processing in the prior reading resume mode setting (prior reading resume setting) set in S611. In the present case, the print job 1024 is expected to be printed, and the total print time for the print job 1024 including the print preparation time 1031 is 10+5,000=5,010 seconds. Since the accumulated print time 1051 is 0 seconds, the CL remaining time 1052 is 3,000 seconds. Since printing of 10 pages×500 copies=5,000 pages linked to the print job 1024 being the print target cannot be entirely completed within the CL remaining time, the print job is divided into multiple print jobs in such a range that each print job is printable within the CL remaining time. The printing of the print job 1024 requires 5,000 seconds, and the cleaning processing is executed every 3,000 seconds. Accordingly, in the present embodiment, the print job 1024 is divided two print jobs of a print job 1041 and a print job 1043. The print job 1041 is a print job formed of pages as many as the number of pages printable within the CL remaining time. The remaining pages are printed after the regular cleaning processing 1032 as the print job 1043. In this case, setting the prior reading resume mode causes print data reading 1042 of the print job 1043 to be executed in parallel with the regular cleaning processing 1032, and causes resume preparation after the regular cleaning processing 1032 to be performed in advance.

As explained above, in the present embodiment, one of the print modes of the normal resume mode, the prior reading resume mode, and the normal print mode is set depending on the comparison result of the CL remaining time and the print time of the print jobs determined to be in the print range. This enables regular the execution of cleaning processing based on the period of the automatic cleaning processing, and the print quality can be maintained. Moreover, performing the prior reading of the print data in parallel with the cleaning processing allows the print resume to be efficiently performed after completion of the cleaning processing. As a result, the downtime caused by the execution of automatic cleaning processing can be minimized, and a decrease of productivity can be suppressed. Specifically, the decrease of productivity can be suppressed without a decrease in print quality.

### Embodiment 2

In the present embodiment, explanation is given of a mode in which the print mode is set for the print job excluded from the print range by the comparison of the estimated print time and the CL remaining time, based on the unexecuted print job and the sheet remaining amount. In the present embodiment, differences from Embodiment 1 are mainly explained. A configuration of a print system of the present embodiment is the same as the configuration of the print system of Embodiment 1 illustrated in FIG. 1, and detailed explanation thereof is omitted.

### Multiple Job Resume Mode Setting Processing

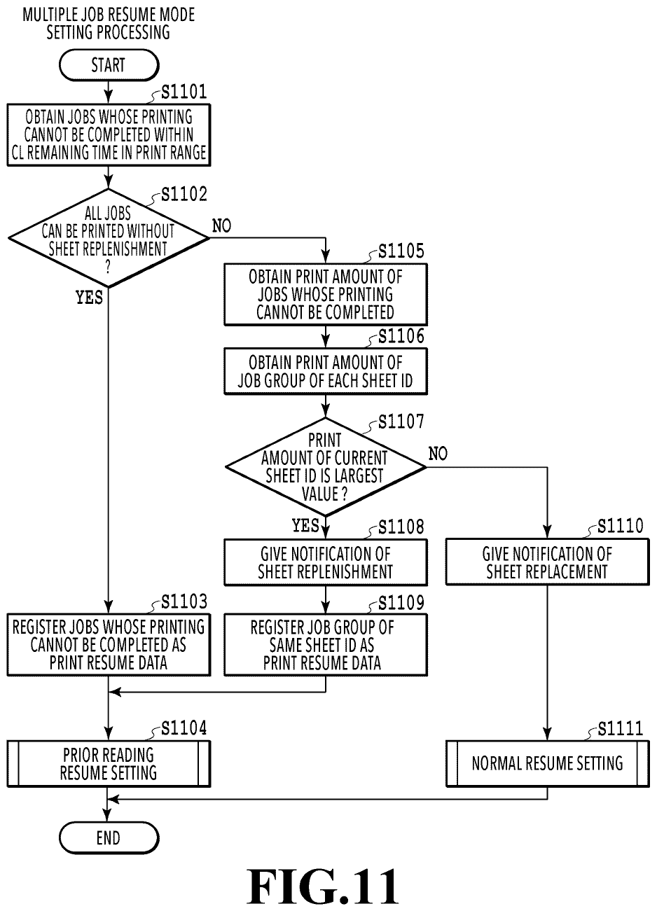

FIG. 11 is a flowchart illustrating a flow of multiple job resume mode setting processing in the case where multiple print jobs are included in the print range in the present embodiment. Overall control of the print mode setting according to the present embodiment is the same as that in the case of FIG. 6. FIG. 11 is a flowchart executed in the case where the print job management unit 302 obtains the determination result indicating that the print job whose printing can be completed is found in S609 (YES in S609). Accordingly, the print jobs are assumed to include at least one print job whose print target is the print range determined in S601 and whose printing cannot be completed within the CL remaining time.

In S1101, the print job management unit 302 obtains the print job whose printing cannot be completed within the CL remaining time, among the print jobs whose print targets are the print range determined in S601. In S1102, the print job management unit 302 checks whether the remaining sheet amount is sufficient for printing of the print range determined in S601. Specifically, the print job management unit 302 checks whether the sheet remaining amount is sufficient for the entire print range determined in S601 to determine whether the job obtained in S1101 can be printed without replacement or replenishment of the sheet after the automatic cleaning processing. In the case where the print job management unit 302 obtains a determination result indicating that the sheet remaining amount is sufficient (YES in S1102), the processing proceeds to S1103.

In S1103, the print job management unit 302 registers the print job obtained in S1101 as print resume data. In S1104, the print job management unit 302 sets the prior reading resume mode to automatically resume the printing after the automatic cleaning processing. Since the prior reading resume mode setting of S1104 is the same operation as FIG. 8B, explanation thereof is omitted. Note that the print job registered in S1103 corresponds to the print resume data in S825. In the case where the process of S1104 is completed, the flowchart illustrated in FIG. 11 is terminated.

Meanwhile, in the case where the print job management unit 302 obtains a determination result indicating that the sheet remaining amount is insufficient and is not enough (NO in S1102), the processing proceeds to S1105. In S1105, the print job management unit 302 obtains a print amount of a portion, of the print range determined in S601, not to be printed. This print amount is obtained to determine processing after the automatic cleaning processing.

In S1106, the print job management unit 302 calculates the print amount for each of the sheet IDs designated in the print jobs for which the RIP is completed and that are registered in the print job management unit 302, excluding the print range determined in S601. Note that a total print amount, that is a sum of print amounts, of the sheet ID of the currently-set sheet is assumed to be a total of calculation results of S1105 and S1106.

In S1107, the print job management unit 302 determines whether the sheet ID whose total print amount, that is the calculated sum of print amounts, is the largest is the sheet ID of the currently-set sheet or not. In the present embodiment, in the case where sheet replenishment or sheet replacement is to be executed, the printing is assumed to be performed such that the print jobs with a largest-possible print amount are executed. In the case where the total print amount of the print jobs in which the sheet ID of the sheet that is currently already set at the print resume is designated as the sheet ID of the sheet to be used is the largest (YES in S1107), the processing proceeds to S1108.

In S1108, the print job management unit 302 gives notification indicating that replenishment of the already-set sheet needs to be performed during the regular cleaning. Although a UI screen is used for the above notification, the notification is not limited to this. For example, sound such as audio guidance, a lamp, or the like may be used for the above notification.

### Sheet Replenishment Notification Screen

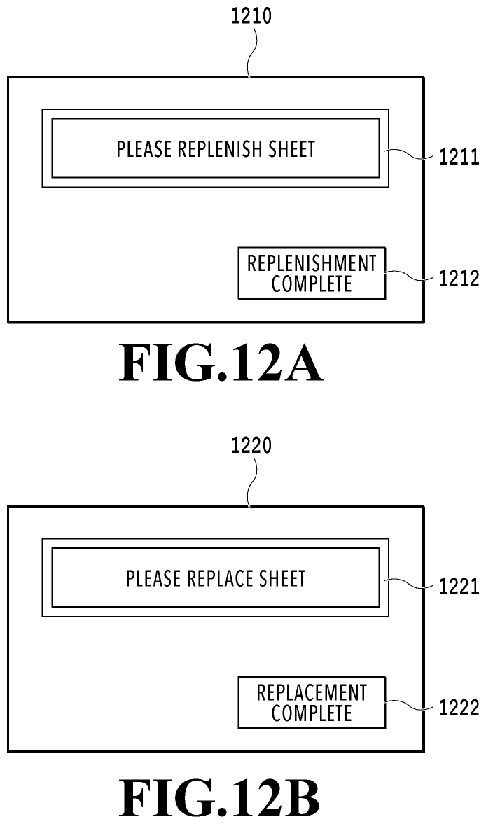

FIG. 12A is a diagram illustrating a sheet replenishment notification screen example. A sheet replenishment notification screen 1210 includes a message 1211 indicating that sheet replenishment needs to be performed during the regular cleaning and a “replenishment complete” button 1212. The “replenishment complete” button 1212 is a button for receiving a user operation in the case where the sheet replenishment is completed. In the case where the “replenishment complete” button 1212 is pressed, the sheet replenishment notification screen 1210 is closed. The sheet replenishment notification screen 1210 may be displayed on the user interface 307 or a display device (not illustrated) of the host apparatus 210. Displaying the sheet replenishment notification screen 1210 including the message 1211 can cause the user to perform replenishment preparation of the sheet. This can suppress downtime that occurs with the sheet replenishment to minimum. Note that the configuration may be such that a change in loaded weight of the sheet in the paper feeding unit is detected, and the sheet replenishment notification screen 1210 is automatically closed in the case where the loaded weight reaches or exceeds a threshold.

In S1109, the print job management unit 302 registers the print job for which the RIP is completed and in which the sheet ID to be a replenishment target is designated, as the print resume data. In the case where the process of S1109 is completed, the processing proceeds to S1104. Note that, in S1104, the print job management unit 302 sets the prior reading resume mode as described above.

Meanwhile, in the case where the total print amount of the print jobs using the sheet ID other than the sheet ID of the sheet that is currently already set is the largest (NO in S1107), the processing proceeds to S1110. In S1110, the print job management unit 302 gives notification indicating that sheet replacement needs to be performed during the regular cleaning. Although the UI screen is used for the above notification, the notification is not limited to this. Sound such as audio guidance, a lamp, or the like may be used for the above notification.

### Sheet Replacement Notification Screen

FIG. 12B is a diagram illustrating a sheet replacement notification screen. A sheet replacement notification screen 1220 includes a message 1221 indicating that sheet replacement needs to be performed during the regular cleaning and a “replacement complete” button 1222. The “replacement complete” button 1222 is a button for receiving a user operation in the case where the sheet replacement is completed. In the case where the “replacement complete” button 1222 is pressed, the sheet replacement notification screen 1220 is closed. The sheet replacement notification screen 1220 may be displayed on the user interface 307 or the display device (not illustrated) of the host apparatus 210. Displaying the sheet replacement notification screen 1220 including the message 1221 can cause the user to perform replacement preparation of the sheet. This can suppress downtime that occurs with the sheet replacement to minimum.

In S1111, the print job management unit 302 sets the normal resume mode. The normal resume mode is set because the sheet ID after the replacement has been determined by the user, and setting the normal resume mode enables obtaining of data matching the used sheet ID without waste. Since the normal resume mode setting of S1111 is the same operation as FIG. 8A, explanation thereof is omitted. In the case where the process of S1111 is completed, the flowchart illustrated in FIG. 11 is terminated.

As explained above, in the present embodiment, in the case where the automatic cleaning processing is executed between print jobs, the printing is temporarily stopped by the execution of automatic cleaning processing. In this period, it is possible to change the print order after the cleaning processing or notify the user to perform the sheet replacement or the sheet replenishment, based on the sheet remaining amount or the like. This enables the subsequent print job to be automatically resumed, and the downtime caused by the execution of automatic cleaning processing can be minimized. Moreover, referring to the job list held by the print job management unit 302 in preparation for the automatic cleaning processing enables presentation of an operation necessary after the automatic cleaning processing such as the sheet replenishment and the sheet replacement, and the resuming after the automatic cleaning processing can be more efficiently performed. Specifically, the decrease in productivity can be suppressed without the decrease in print quality.

### Other Embodiments

The present disclosure is not limited to the above-mentioned embodiments. In the present embodiments, explanation is given of the case where the prior reading resume mode is enabled in the situation where the resume target after the cleaning processing is clear such as the situation where the automatic cleaning processing is performed in the middle of printing or the sheet remaining amount is sufficient and the continuous printing is thus possible. The present disclosure is not limited to this, and for example, the configuration may be such that the prior reading resume setting is always enabled to prioritize the job being printed, and the user is notified of operations according to the prior reading resume setting such as the sheet replenishment and the sheet replacement. Moreover, the automatic cleaning processing may be executed with the automatic cleaning period provided with a window time such that the job is continuously printed as much as possible. The configuration may be such that software (program) that implements the functions of the above-mentioned embodiments is supplied to a system or an apparatus via a network or various storage media, and a computer (or a CPU, a MPU, or the like) of the system or the apparatus reads and executes the program.

Although the case where the sheet remaining amount is obtained is explained in Embodiment 1 described above, the present disclosure is not limited to this, and the sheet remaining amount does not have to be obtained.

Although the case where the sheet remaining amount is obtained in S605 of FIG. 6 is explained in Embodiment 2 described above, the present disclosure is not limited to this, and the obtaining of the sheet remaining amount may be executed immediately after or before the start of the multiple job resume mode setting processing.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present embodiments, it is possible to suppress the decrease in productivity while avoiding the decrease in print quality.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-001856, filed Jan. 10, 2024, which is hereby incorporated by reference wherein in its entirety.

What is claimed is:

1. A printing apparatus that performs regular cleaning processing on a print mechanism of a roll paper, the printing apparatus comprising:
a storage unit configured to store an inputted print job; and
a control unit configured to control execution of the print job stored in the storage unit in a predetermined period, wherein
in a case where a plurality of the print jobs are stored in the predetermined period, the control unit determines the print job to be preferentially executed based on a remaining time to start of the regular cleaning processing and a total print time taken to execute one or more of the print jobs in which a type of roll paper set in the print mechanism is designated as a type of roll paper to be used among the plurality of print jobs.

2. The printing apparatus according to claim 1, wherein, in a case where the total print time is longer than the remaining time and one or more of the print jobs whose printing is completable within the remaining time are present, the control unit determines the one or more of the print jobs whose printing is completable within the remaining time as the print job to be preferentially executed.

3. The printing apparatus according to claim 2, wherein, in a case where the regular cleaning processing is completed after execution of the one or more of the print jobs whose printing is completable within the remaining time, the control unit obtains one or more of the print jobs whose printing is incompletable within the remaining time among the one or more of the print jobs in which the type of roll paper set in the print mechanism is designated, as the print job to be preferentially executed.

4. The printing apparatus according to claim 2, wherein, in a case where printing on the roll paper set in the print mechanism is possible without replenishment of the roll paper based on all of the print jobs whose printing is completable within the remaining time, the control unit registers one or more of the print jobs whose printing is incompletable within the remaining time, as resume data used in the printing resumed after completion of the regular cleaning processing.

5. The printing apparatus according to claim 4, wherein the control unit reads the resume data in a case where the regular cleaning processing is performed after execution of all of the print jobs whose printing is completable within the remaining time.

6. The printing apparatus according to claim 2, further comprising a notification unit configured to give notification of information, wherein
in a case where printing on the roll paper set in the print mechanism is impossible without replenishment of the roll paper based on all of the print jobs whose printing is completable within the remaining time and a print amount of the roll paper set in the print mechanism is the largest among total print amounts of the respective types of roll papers designated in the plurality of print jobs, the notification unit gives notification of information indicating that the roll paper needs to be replenished.

7. The printing apparatus according to claim 6, wherein the control unit registers one or more of the print jobs in which the type of roll paper set in the print mechanism is designated, as resume data used in the printing resumed after completion of the regular cleaning processing.

8. The printing apparatus according to claim 7, wherein the control unit reads the resume data in a case where the regular cleaning processing is performed after execution of the print jobs whose printing is completable within the remaining time.

9. The printing apparatus according to claim 6, wherein the notification unit gives the notification of information via a UI screen.

10. The printing apparatus according to claim 2, further comprising a notification unit configured to give notification of information, wherein
in a case where printing on the roll paper set in the print mechanism is impossible without replenishment of the roll paper based on all of the print jobs whose printing is completable within the remaining time and a print amount of the roll paper set in the print mechanism is not the largest among total print amounts of the respective types of roll papers designated in the plurality of print jobs, the notification unit gives notification of information indicating that the roll paper needs to be replaced.

11. The printing apparatus according to claim 10, wherein the notification unit gives the notification of information via a UI screen.

12. The printing apparatus according to claim 2, wherein, in a case where the total print time is longer than the remaining time and the print job whose printing is completable within the remaining time is absent, the control unit determines a page whose printing is completable within the remaining time.

13. The printing apparatus according to claim 12, wherein, in a case where the regular cleaning processing is performed after printing of the page whose printing is completable within the remaining time, the control unit reads a page whose printing is incompletable within the remaining time.

14. The printing apparatus according to claim 13, wherein, in a case where: the page whose printing is completable within the remaining time is printed; the regular cleaning processing is completed; and the printing is resumed, the control unit executes the print job in which the type of roll paper set in the print mechanism is designated, between operations of the regular cleaning processing.

15. The printing apparatus according to claim 1, wherein, in the case where there is no remaining time, the control unit performs control to start the regular cleaning processing.

16. The printing apparatus according to claim 1, wherein the storage unit stores each of the print jobs, the type of roll paper, a print time taken to execute the print job, and a print amount in a case where the print job is executed, in link with one another.

17. A control method of a printing apparatus performing regular cleaning processing on a print mechanism of a roll paper, the control method comprising:
storing an inputted print job; and
controlling execution of the print job stored in the storing in a predetermined period, wherein
in the controlling, in a case where a plurality of the print jobs are stored in the predetermined period, the print job to be preferentially executed is determined based on a remaining time to start of the regular cleaning processing and a total print time taken to execute one or more of the print jobs in which a type of roll paper set in the print mechanism is designated as a type of roll paper to be used among the plurality of print jobs.

18. A non-transitory computer readable storage medium storing a program for causing a computer to perform a control method of a printing apparatus performing regular cleaning processing on a print mechanism of a roll paper, the control method comprising:
storing an inputted print job; and
controlling execution of the print job stored in the storing in a predetermined period, wherein
in the controlling, in a case where a plurality of the print jobs are stored in the predetermined period, the print job to be preferentially executed is determined based on a remaining time to start of the regular cleaning processing and a total print time taken to execute one or more of the print jobs in which a type of roll paper set in the print mechanism is designated as a type of roll paper to be used among the plurality of print jobs.
